(19) United States
(12) Patent Application Publication
(10) Pub. No.: US 2016/0360181 A1
(43) Pub. Date: Dec. 8, 2016

(54) 4D Electromagnetic Surveillance System to Capture Visible and Non-visible Events and Method of Operation

(71) Applicant: Dean Drako, Austin, TX (US)

(72) Inventor: Dean Drako, Austin, TX (US)

(21) Appl. No.: 14/732,672

(22) Filed: Jun. 6, 2015

(51) Int. Cl. H04N 13/02; H04N 5/232; G06K 9/00; H04B 1/40; G06T 7/00

(52) U.S. Cl. CPC H04N 13/0207; H04B 1/40; G06T 7/0046; G06K 9/00369; G06K 9/00771; H04N 13/0271; H04N 13/0285; H04N 5/23293; G06T 2200/04; G06T 2207/10028; G06T 2207/30232

(57) ABSTRACT

A 4D event recordation terminal has visible spectrum and non-visible spectrum sensors co-aligned over a field of view. Non-visible spectrum sensors receive electromagnetic fields emitted by mobile wireless devices either probing or responding to a transceiver. Unique equipment identity codes may be received, timestamped, and stored as non-visible events when the equipment enters or leaves the field of view. A non-visible event triggers a visible event capture by a 3D camera. Entry or exit through a portal in the field of view triggers a visible event capture by the 3D camera and by the transceiver. A first transformation apparatus associates a thumbnail of an image next to each non-visible event recordation. A directional beam antenna locates an angular source of a non-visible event. A second transformation apparatus associates a textual tag mapped to a unique equipment identity code to a humanoid skeleton segment such as a hand or wrist.

### CROSS-REFERENCES TO RELATED APPLICATIONS

None.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISK OR AS A TEXT FILE VIA THE OFFICE ELECTRONIC FILING SYSTEM (EFS-WEB)

Not Applicable

### STATEMENT REGARDING PRIOR DISCLOSURES BY THE INVENTOR OR A JOINT INVENTOR

Not Applicable

### BACKGROUND OF THE INVENTION

### Technical Field

The field of the invention is electronic security identification and surveillance.

### Description of the Related Art

As is known, The IEEE 802.11 standard is a set of media access control (MAC) and physical layer (PHY) specifications for implementing wireless local area network (WLAN) computer communication in the 2.4, 3.6, 5, and 60 GHz frequency bands. The standard and amendments provide the basis for wireless network products using the Wi-Fi brand.

Each service set has an associated identifier, the Service Set Identifier (SSID), which consists of 32 bytes that identifies the particular network. The SSID is configured within the devices that are considered part of the network, and it is transmitted in the packets. Receivers ignore wireless packets from other networks with a different SSID.

MAC address is part of the 802.11 header that is never encrypted.

A media access control address (MAC address) is a unique identifier assigned to network interfaces for communications on the physical network segment. MAC addresses are used as a network address for most IEEE 802 network technologies, including Ethernet and WiFi. Logically, MAC addresses are used in the media access control protocol sublayer of the OSI reference model.

MAC addresses are most often assigned by the manufacturer of a network interface controller (NIC) and are stored in its hardware, such as the card's read-only memory or some other firmware mechanism. If assigned by the manufacturer, a MAC address usually encodes the manufacturer's registered identification number and may be referred to as the burned-in address (BIA). It may also be known as an Ethernet hardware address(EHA), hardware address or physical address. This can be contrasted to a programmed address, where the host device issues commands to the NIC to use an arbitrary address.

MAC addresses are formed according to the rules of one of three numbering name spaces managed by the Institute of Electrical and Electronics Engineers (IEEE): MAC-48, EUI-48, and EUI-64. The IEEE claims trademarks on the names EUI-48 and EUI-64, in which EUI is an abbreviation for Extended Unique Identifier.

The following technologies use the MAC-48 identifier format:
802.11 wireless networks
Bluetooth

Every device that connects to an IEEE 802 network (such as Ethernet and Wi-Fi) has a MAC-48 address. Common consumer devices to use MAC-48 include every PC, smartphone or tablet computer.

The distinction between EUI-48 and MAC-48 identifiers is purely nominal: MAC-48 is used for network hardware; EUI-48 is used to identify other devices and software. (Thus, by definition, an EUI-48 is not in fact a “MAC address”, although it is syntactically indistinguishable from one and assigned from the same numbering space.)

The IEEE now considers the label MAC-48 to be an obsolete term, previously used to refer to a specific type of EUI-48 identifier used to address hardware interfaces within existing 802-based networking applications, and thus not to be used in the future. Instead, the proprietary term EUI-48 should be used for this purpose.

As a result of users being trackable by their devices' MAC addresses, Apple Inc. has started using random MAC addresses in their iOS line of devices while scanning for networks. If random MAC addresses are not used, researchers have confirmed that it is possible to link a real identity to a particular wireless MAC address.

Amongst the multiple information contained in frame headers, there are the source and the destination MAC addresses. A MAC address is a 48 bits number used to uniquely identify a network interface. MAC addresses are attributed to interface vendors by block of 224. As a result the 24 leftmost bits of a MAC address can be used to identify the interface's manufacturer. In any frame, the source address field of the header contain the MAC address of the emitting interface. As noted before, the frame headers are never encrypted, therefore the source MAC address is available in plaintext in all the frames emitted by a device. This would be of limited importance if Wi-Fi devices were emitting frames only when connected to a network, but in fact, because of service discovery mechanisms, they transmit frames even when they are not connected.

### Configured Network List

Most operating systems are storing a list of wireless networks to which the device have been connected to. This list is called the Configured Network List (CNL) and contains information such as the network's SSID and its security features.

### Service Discovery

The Wi-Fi technology features a service discovery mechanism, which allows stations to discover the access points in range. Two variant of service discovery are co-existing. In the first one, called passive service discovery, APs are periodically advertising their presence by broadcasting beacon frames containing various information (SSID, security features), while stations passively listen to those beacons to discover APs in range. In the second, called the active service discovery, the station plays an active role by periodically probing the neighbourhood with probe request frames to which AP respond with probe response frames.

It is known that wireless mobile devices have at least one of Bluetooth address, wifi address, IMEI, IMSI, IP address, and MAC address.

It is known that 802.11, LTE, and Bluetooth standards support operation in the 2.4-2.5 GHz spectrum range.

### BRIEF SUMMARY OF THE INVENTION

A 4D event recordation terminal has visible spectrum and non-visible spectrum sensors co-aligned over a field of view. A surveillance system records events of interest sensed by 2D or 3D cameras in combination with a radio receiver.

Non-visible spectrum sensors receive electromagnetic fields emitted by mobile wireless devices either probing or responding to a transceiver. A WIFI access point identifies itself and offers connectivity to a mobile equipment. Or an RFID/Bluetooth/LTE station interrogates or authenticates using IP or MAC address.

Unique equipment identity codes may be received, timestamped, and stored as non-visible events when the equipment enters or leaves the field of view. The system logs entry or exit of each unique equipment identity code. It may be supplemented by data from member or employment records. It may be supplemented from public records or transaction histories of a retail establishment using electronic payment systems. It may be supplemented by a reverse phone directory service.

A non-visible event triggers a visible event capture by a 3D camera. Upon receiving a probe or a response from a wireless device, the system triggers an event capture by the visible spectrum sensors. The trigger may occur at signal maximum or upon crossing a threshold in signal strength. The trigger may occur for a previously unknown or unregistered wireless device.

Passage through a portal in the field of view triggers a visible event capture by the 3D camera and by the transceiver. Using depth pixels to distinguish a foreground from a background object, an event capture is triggered when an object enters or leaves through a portal within the field of view. The camera captures a visible image. The transceiver captures an electromagnetic signature. An alert is triggered for a person entering or departing without any active wireless device.

A first transformation apparatus associates a thumbnail of an image next to each non-visible event recordation. A list of time-stamped unique equipment identity codes is retrieved from non-visible event storage. The identity codes are mapped to names of service subscribers. Using the timestamps one or more thumbnail images captured by the camera are arranged adjacent to each identity.

A directional beam antenna locates an angular source of a non-visible event. A phased-array antenna resolves angular direction of signal beams to a few degrees. Each unique equipment identity code is associated with at most four pixel blocks within the field of view of the 3D camera.

A second transformation apparatus associates a textual tag mapped to a unique equipment identity code to a humanoid skeleton segment such as a hand or wrist. A skeletonization circuit uses depth and visible light to determine a humanoid skeleton within the 3D camera field of view. The source of a unique equipment identity code is displayed positionally on a segment of a skeleton.

The method of operation includes, capturing, by a video camera a sequence of images of a humanoid transiting a venue; inviting, by a signal transmitter, connection with any mobile wireless device within the venue; receiving and decoding a wireless device address or id; associating an image of a humanoid with the wireless device address or id and displayed or stored; and associating by a skeletonization circuit and a directed beam antenna the address or id with one of a plurality of humanoids in the field of view of the camera.

### BRIEF DESCRIPTION OF THE SEVERAL VIEWS OF THE DRAWINGS

To further clarify the above and other advantages and features of the present invention, a more particular description of the invention will be rendered by reference to specific embodiments thereof that are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 is a block diagram of a system.

### DETAILED DISCLOSURE OF EMBODIMENTS OF THE INVENTION

One aspect of the invention is a 4D event recordation terminal having visible spectrum and non-visible spectrum sensors co-aligned over a field of view.

The non-visible spectrum sensors receive electromagnetic fields emitted by mobile wireless devices either probing or responding to a transceiver.

Unique equipment identity codes may be received, timestamped, and stored as non-visible events when the equipment enters or leaves the field of view.

A non-visible event triggers a visible event capture by a 3D camera.

Entry or exit through a portal in the field of view triggers a visible event capture by the 3D camera and by the transceiver.

A first transformation apparatus associates a thumbnail of an image next to each non-visible event recordation.

A directional beam antenna locates an angular source of a non-visible event.

A second transformation apparatus associates a textual tag mapped to a unique equipment identity code to a humanoid skeleton segment such as a hand or wrist.

One aspect of the invention includes a 3-D video camera having a field of view; a directional antenna that has a main lobe aligned with the field of view; a signal transmitter circuit coupled to the directional antenna; a humanoid skeletonization circuit coupled to the 3-D video camera; a display coupled to the skeletonization circuit; a signal receiver coupled to the antenna; a wireless device address and id recordation circuit; and a circuit to associate a wireless device address or id with a humanoid skeleton when a signal was received, the signal being one of 802.11, LTE, and Bluetooth; and a store to record the camera image with the device address or id.

One aspect of the invention includes a 3-D video camera having a field of view; a directional antenna that has a main lobe aligned with the field of view; a signal transmitter circuit coupled to the directional antenna; a humanoid skeletonization circuit coupled to the 3-D video camera; a display coupled to the skeletonization circuit; a directed beam phased-array antenna; a beam direction controlling circuit; a signal receiver coupled to the direct beam phased-array antenna; a wireless device address and id recordation circuit; a circuit to associate a wireless device address or id with a humanoid skeleton at the beam direction when a signal was received, the signal being one of 802.11, LTE, and Bluetooth; and a store to record the camera image with the device address or id.

Another aspect of the invention includes a directed beam phased-array antenna; a beam direction controlling circuit; a signal transceiver coupled to the direct beam phased-array antenna; a wireless device address and id recordation circuit; a 3-D video camera having a field of view covering the phased-array antenna's maximum scanning angle; a humanoid skeletonization circuit coupled to the 3-D video camera; a circuit to associate a wireless device address or id with a humanoid skeleton at the beam direction when a signal was received, wherein the signal being one of 802.11, LTE, and Bluetooth, and a store to record the camera image with the device address or id.

One aspect of the invention is a 4D event recordation system which has an event recordation terminal having a depth sensor, a visible spectrum sensor, and an electromagnetic sensor co-aligned over a field of view; a circuit to receive electromagnetic fields emitted by mobile wireless devices either probing or responding to a transceiver; a circuit to determine unique equipment identity codes of mobile wireless devices within the field of view; and a circuit to timestamp, and store identity codes as non-visible events when the equipment enters or leaves the field of view.

In an embodiment, the system also has a circuit to trigger a visible event capture by a 3D camera upon determining a non-visible event.

In an embodiment, the system also has a circuit to determine passage through a portal in the field of view to trigger a visible event capture by the 3D camera and by the transceiver.

In an embodiment, the system also has a first transformation apparatus associates a thumbnail of an image with each non-visible event recordation.

In an embodiment, the system also has a directional beam antenna coupled to the electromagnetic sensor to locate an angular source of a non-visible event.

In an embodiment, the system also has a second transformation apparatus to associate a textual tag mapped to a unique equipment identity code to a humanoid skeleton segment such as a hand or wrist.

Another aspect of the invention is a system having a electromagnetic signal transceiver; a circuit to trigger an event upon signal strength passing through a threshold or a maximum; a circuit to record a unique identifier of a mobile wireless device; and a circuit to search a store of personal identifiers associated with each unique identifier.

In an embodiment, a personal identifier is a car license plate.

In an embodiment, a personal identifier is a billing address.

In an embodiment, a personal identifier is an IMEI of a mobile telephone subscriber.

In an embodiment, the system also has a 2D video surveillance camera coupled to the transceiver to capture a visible image upon receiving an event trigger; a store to contain unique identifiers and video images; and a time and location identifier.

In an embodiment, the system also has a directed beam phased array antenna coupled to the transceiver to determine an angular direction for the received unique identifier; and a transformation circuit to annotate a list of unique identifiers with a thumbnail of a video frame.

Another aspect of the invention is a system including a 3D camera; a skeletonization circuit; and a circuit to trigger an event upon the skeleton occupies a field of view within a range of depth from the camera.

In an embodiment, the system also has an electromagnetic signature sensor to receive a unique identifier of a mobile wireless device within the field of view of the 3D camera; a circuit to trigger an event on the condition that a skeleton is detected without an electromagnetic signature; and a store for unique identifiers received by the sensor.

In an embodiment, the system also has a phased array beam steering antenna coupled to the signature sensor to determine an angular beam direction of a signal from a mobile wireless device; and a transformation circuit to associate the identifier with a skeleton or segment of a skeleton.

Another aspect of the invention is a system comprising a directed beam antenna; beam steering circuitry; a transceiver; a store for beam direction and unique identifier codes.

In an embodiment, the system also has depth sensor to determine the presence of an object in the foreground of a field of view of the directed beam antenna.

In an embodiment, the system also has a 2D visible spectrum sensor and a skeletonization circuit.

In an embodiment, a unique identifier is one of one of an IMEI, a Bluetooth id, an EUI-64, an EUI-48, a MAC-48, an IPv4 address, an IPv6 address, a burned-in address, an Ethernet hardware address, hardware address, or physical address, an Extended Unique Identifier, and a media access control (MAC) address.

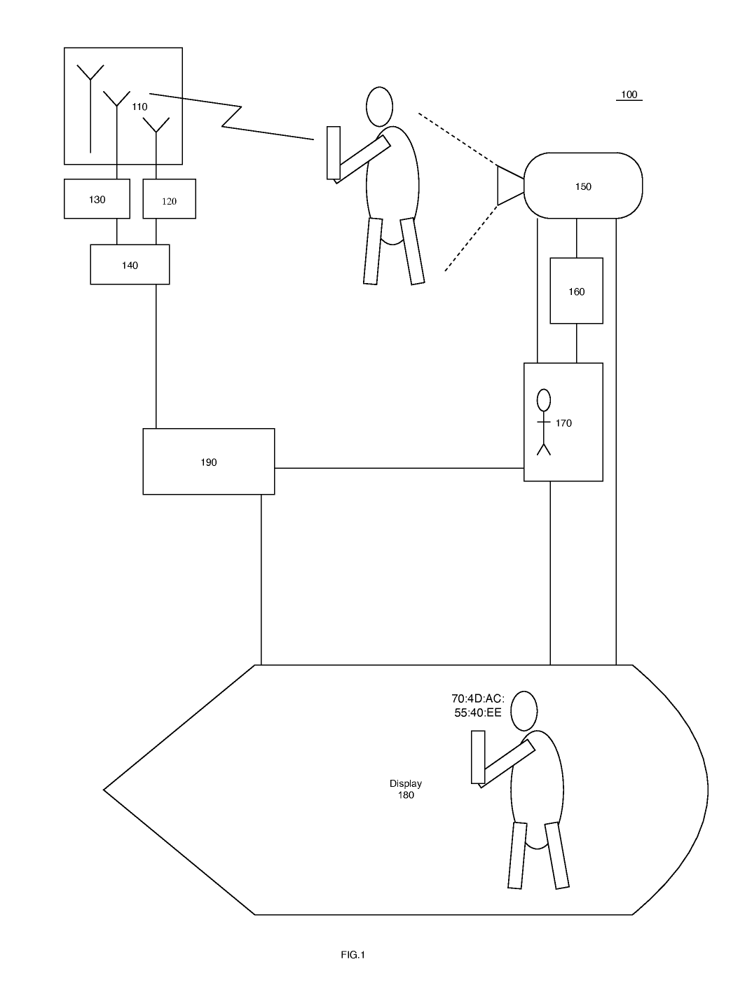

Referring now to FIG. 1, in an embodiment, an electromagnetic surveillance system 100 includes: a phased array antenna (antenna) 110; a radio frequency beam directing circuit (rfpointer) 120, the pointer coupled to the antenna; at least one wireless communication transceiver (radio) 130, the radio coupled to the pointer; a transmitter identification circuit (txid) 140, the txid coupled to the radio and to the pointer; a dual stream camera (3Dcam) 1 50; a depth map store (dstore) 160, the dstore coupled to the 3Dcam; a humanoid skeletonization circuit (skelcir) 170, the skelcir coupled to the 3Dcam and to the dstore; a video display (display) 180, the display coupled to the 3Dcam and to the skelcir; and an overlay circuit to position a transmitter identifier on the video display at the coordinate of the beam direction when the transmitter identified itself (idmerger) 190, the idmerger coupled to the rfpointer, to the txid, to the skelcir, and to the display. It is understood that circuits described above can be implemented as digital logic gates in a mask programmed standard cell or gate array. The circuits may equally be embodied in a programmable logic device depending on fuses or electrically erasable flash memory or firmware. The circuits may equally be embodied in Field Programmable Gate Arrays configured by non-transitory storage such as flash or read only memories (ROM). The circuits above may equally be embodied as processors adapted by instructions in non-transitory storage to perform the specific logic functions.

### CONCLUSION

The present invention can be easily distinguished by its transformation of captured images with electronic electromagnetic unique identity codes associated by time, place, and angular direction.

The techniques described herein can be implemented in digital electronic circuitry, or in computer hardware, firmware, software, or in combinations of them. The techniques can be implemented as an embedded microcontroller, i.e., firmware tangibly embodied in a non-transitory medium, e.g., in a machine-readable storage device, for execution by, or to control the operation of circuit apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and connected by a wireless network.

Method steps of the techniques described herein can be performed by one or more programmable processors executing a computer program to perform functions of the invention by operating on input data and generating output. Method steps can also be performed by, and apparatus of the invention can be implemented as, special purpose logic circuitry, e.g., an FPGA (field programmable gate array) or an ASIC (application-specific integrated circuit). Modules can refer to portions of the computer program and/or the processor/special circuitry that implements that functionality.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices. The processor and the memory can be supplemented by, or incorporated in special purpose logic circuitry.

A number of embodiments of the invention have been described. Nevertheless, it will be understood that various modifications may be made without departing from the spirit and scope of the invention. For example, other network topologies may be used. Accordingly, other embodiments are within the scope of the following claims.

I claim:

1. A 4D event recordation system comprises:
an event recordation terminal having a depth sensor, a visible spectrum sensor, and an electromagnetic sensor co-aligned over a field of view;
a circuit to receive electromagnetic fields emitted by mobile wireless devices either transmitting a probe request or responding to a transceiver;
a circuit to determine unique equipment identity codes of mobile wireless devices within the field of view; and
a circuit to timestamp, and store identity codes as non-visible events when the equipment enters or leaves the field of view.

2. The system of claim 1 further comprising:
a circuit to trigger a visible event capture by a 3D camera upon determining a non-visible event.

3. The system of claim 1 further comprising:
a circuit to determining passage through a portal in the field of view to trigger a visible event capture by the 3D camera and by the transceiver.

4. The system of claim 1 further comprising:
a first transformation apparatus to associate a thumbnail of an image with each non-visible event recordation.

5. The system of claim 1 further comprising:
a directional beam antenna coupled to the electromagnetic sensor to locate an angular source of a non-visible event.

6. The system of claim 5 further comprising:
a second transformation apparatus to associate a textual tag mapped to a unique equipment identity code to a humanoid skeleton segment such as a hand or wrist.

7. A system comprising:
a electromagnetic signal transceiver;
a circuit to trigger an event upon signal strength passing through a threshold or a maximum;
a circuit to record a unique identifier of a mobile wireless device; and
a circuit to search a store of personal identifiers associated with each unique identifier.

8. The system of claim 7 wherein a personal identifier is a car license plate.

9. The system of claim 7 wherein a personal identifier is an billing address.

10. The system of claim 7 wherein a personal identifier is an IMEI of a mobile telephone subscriber.

11. The system of claim 7 further comprising:
a 2D video surveillance camera coupled to the transceiver to capture a visible image upon receiving an event trigger;
a store to contain unique identifiers and video images; and
a time and location identifier.

12. The system of claim 11 further comprising:
a directed beam phased array antenna coupled to the transceiver to determine an angular direction for the received unique identifier; and
a transformation circuit to annotate a list of unique identifiers with a thumbnail of a video frame.

13. A system comprising:
a 3D camera;
a skeletonization circuit; and
a circuit to trigger an event upon the skeleton occupying a field of view within a range of depth from the camera.

14. The system of claim 13 further comprising:
an electromagnetic signature sensor to receive a unique identifier of a mobile wireless device within the field of view of the 3D camera;
a circuit to trigger an event on the condition that a skeleton is detected without an electromagnetic signature; and
a store for unique identifiers received by the sensor.

15. The system of claim 14 further comprising:
a phased array beam steering antenna coupled to the signature sensor to determine an angular beam direction of a signal from a mobile wireless device; and
a transformation circuit to associate the identifier with a skeleton or segment of a skeleton.

16. A system comprising:
a directed beam antenna (antenna), the antenna coupled to
a transceiver, the transceiver coupled to a WiFi beacon, and
a store to record an angular direction and a unique identity code received from that angular direction.

17. The system of claim 16 further comprising depth sensor to determine the presence of an object in the foreground of a field of view of the directed beam antenna.

18. The system of claim 17 further comprising a 2D visible spectrum sensor and a skeletonization circuit

19. The system of claim 16 wherein a unique identifier is one of an IMEI, a Bluetooth id, an EUI-64, an EUI-48, a MAC-48, an IPv4 address, an IPv6 address, a burned-in address, an Ethernet hardware address, hardware address, or physical address, an Extended Unique Identifier, and a media access control (MAC) address.

20. An electromagnetic surveillance system comprises:
a phased array antenna (antenna);
a radio frequency beam directing circuit (rfpointer), the pointer coupled to the antenna;
at least one wireless communication transceiver (radio), the radio coupled to the pointer;
a transmitter identification circuit (txid), the txid coupled to the radio and to the pointer;
a dual stream camera (3Dcam);
a depth map store (dstore), the dstore coupled to the 3Dcam;
a humanoid skeletonization circuit (skelcir), the skelcir coupled to the 3Dcam and to the dstore;
a video display (display), the display coupled to the 3Dcam and to the skelcir; and
an overlay circuit to position a transmitter identifier on the video display at the coordinate of the beam direction when the transmitter identified itself (idmerger), the idmerger coupled to the rfpointer, to the txid, to the skelcir, and to the display.
